(19) United States
(12) Patent Application Publication
(10) Pub. No.: US 2010/0104793 A1
(43) Pub. Date: Apr. 29, 2010

(54) ORIENTED TEAR ZONE FOR A PLASTIC FILM

(76) Inventor: Stephane Mathieu, Voluvry (CH)

Correspondence Address: NIXON & VANDERHYE, PC, 901 NORTH GLEBE ROAD, 11TH FLOOR, ARLINGTON, VA, 22203, US

(21) Appl. No.: 12/532,537

(22) PCT Filed: Mar. 17, 2008
(86) PCT No.: PCT/IB2008/051005

§ 371 Date: Oct. 15, 2009

(30) Foreign Application Priority Data
Mar. 24, 2007 (EP) 07104843.3

(51) Int. Cl. B65D 65/28; B29C 65/02; B32B 38/04

(52) U.S. Cl. 428/43; 156/304.6; 156/256; 156/257; 156/512

(57) ABSTRACT

The invention relates to a plastic film (3) including a pre-existing oriented tear zone (11, 7), characterised in that the zone (11, 7) comprises a butt weld (7) which assembles one end of the plastic film (9) with another end of the plastic film (10), said weld zone being disposed in the thickness of one or more of the welding layers of the plastic film (3). The invention also relates to a method and a device for producing said plastic film.

### FIELD OF THE INVENTION

The present invention relates to plastic films that have at least one preexisting fragile zone designed to form an oriented tear zone. Such plastic films are notably used in the field of packaging when a part of a container is torn so that its content can be removed.

### STATE OF THE ART

In the present text, the term “welding” should be understood to mean an operation by which two pieces are joined together, with or without a filler material, by causing their edges to melt, so as to obtain a uniform, smooth and very strong joint. The term “weld” should be understood to be the result of welding.

These days, plastic films are used in many applications and in particular in packaging. The plastic films can be single-layer or multilayer and can be obtained by cast extrusion, extrusion blow-molding, by film coating, by hot lamination or by pasting. They can be printed or neutral.

One of the problems encountered with films in the state of the art is the difficulty in tearing them (the force required is often high), at least in tearing them in a predefined direction.

To overcome these defects, various means have been developed:

1—In Plastic Film

Strippability

Strippability is a way of overcoming the tear problem by opening a bag using the strippability of the welds which are positioned at the edges of the bag. This solution has the drawback of requiring a particular welding film, which is more expensive than the conventional solutions. Also, the resultant product is weaker than in the case of a true weld, which makes it more fragile (when it comes to pressure resistance, for example).

Oriented Plastic Films

These films require specific manufacture which significantly increases the price of the film. Their effectiveness when it comes to the orientation of the tear remains relative for most of them. Another drawback lies in the fact that the mechanical properties of the film are greatly modified by this orientation: A greater fragility to impact is generally observed (drop test, for example).

To sum up, these changes have an effect, first, on the price of the film and, second, on its general behavior (flexibility, strength of the welds, impact resistance, etc.). These two aspects greatly limit the development of these solutions.

2—In the Plastic Film Manufacturing Method

Embrittlement by laser precutting (see, for example, patent applications WO 9829312 and EP 0540184). Laser precutting is used to partially cut a multi-layer plastic film. Its main limitation is that it requires a specific and costly installation. This technology, which has been in existence for a very long time, is little used.

Embrittlement by mechanical precutting (see, for example, patent application EP 1094013). Precutting is generally done over the entire thickness of the plastic film; in this case, the plastic film is pierced. In the case of a partial cut in the thickness (just one layer, for example), the seal-tightness of the weld becomes difficult to obtain if the welding plastic film is entirely cut. If a bi-oriented layer is entirely cut, there can be a significant loss of mechanical strength.

Tear oriented by guidance (see, for example, patent application WO 03045816).

This solution applies only to films that are easy to tear so as to guide the tear.

These methods do, however, incur industrial overheads mainly associated with investments, additional steps in the method or productivity losses.

There is consequently a need to remedy the problems of the state of the art explained hereinabove.

### GENERAL DESCRIPTION OF THE INVENTION

The subject matter of the present invention relates to a plastic film comprising a preexisting oriented tear zone. The plastic film according to the invention is characterized in that said zone comprises at least one butt weld joining two parts of the plastic film.

The term “part” should be understood to mean any surface portion of the film, generally a surface portion positioned in the thickness of the film, in a direction perpendicular to the surface of the film. The “part” is also the surface portion that is in contact with the weld.

This definition means that, if the weld extends to a depth F that is less than or equal to the thickness of the film, the part also extends to a depth F.

In the present invention, the weld is advantageously produced by abutting the two parts of the film. The expression “butt weld” should be understood to mean a region in which two films that are not overlaid are joined at their ends, the latter possibly being overlaid, but over a maximum distance of 1 mm.

According to one embodiment of the invention, the plastic film consists of several overlaid layers. In this case, the weld can join all the layers or only some, even just one of them.

In a variant of the invention, the weld is located in a region defined by bringing two ends of the plastic film into contact, for example, by winding.

In another variant of the invention, a slot is produced in the plastic film, the slot having a depth equal to or less than the thickness of the plastic film. Once produced, the slot is totally or partially sealed by welding.

Regardless of the method used, the welding can be done over all or part of the surface that can be used for this purpose. The depth of the weld can be less than the depth of the slot, whether or not the latter is of a thickness equivalent to that of the plastic film.

The invention also relates to a method for manufacturing a preexisting oriented tear zone in a plastic film, characterized in that said zone is obtained by attaching two parts of said plastic film by means of a weld.

Advantageously, the method according to the invention includes the displacement of a plastic film in a direction, the cutting of the plastic film in a direction identical to the direction of movement of the plastic film and the welding of the edges of the resulting slot.

Finally, the invention also relates to a device for implementing the abovementioned method.

### DETAILED DESCRIPTION OF THE INVENTION

The invention will be better understood hereinbelow from examples illustrated by the following figures:

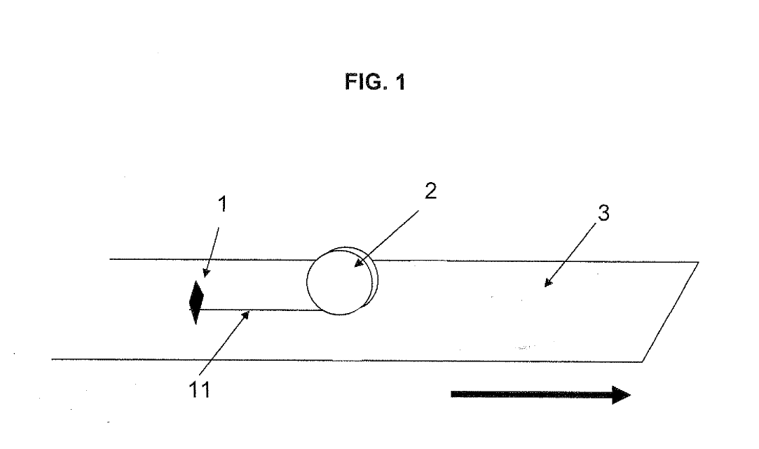

FIG. 1 diagrammatically shows a method according to the invention;

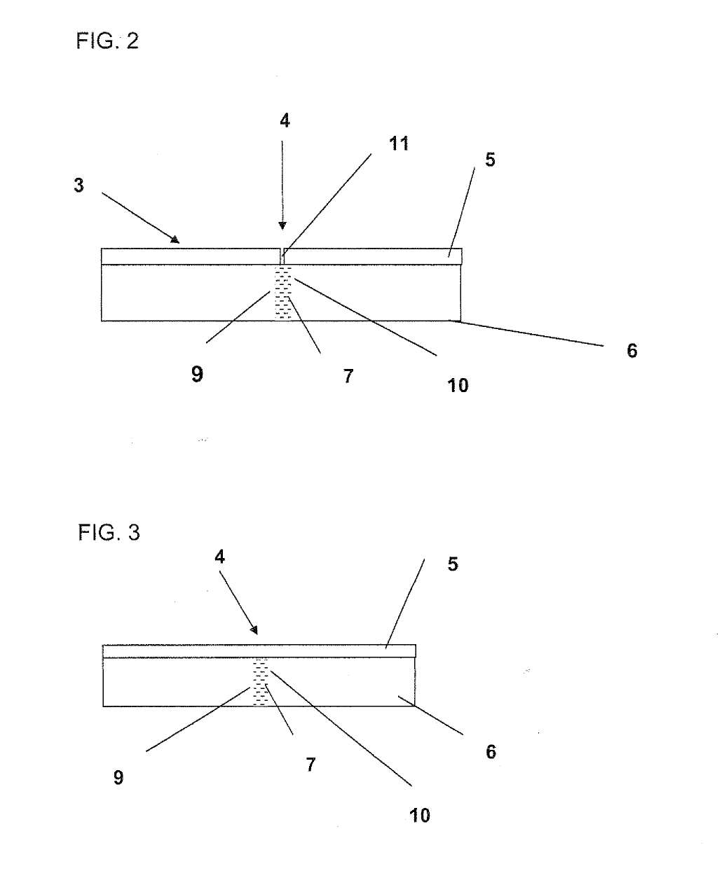

FIG. 2 shows an example of a two-layer plastic film with a welding layer and a non-welding layer;

FIG. 3 presents a two-layer plastic film similar to that of FIG. 2, but differing in that the non-welding layer is not cut;

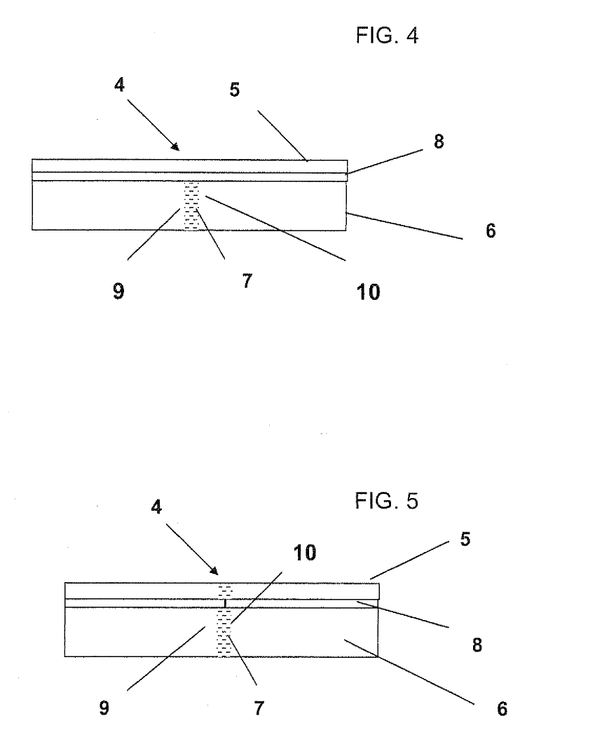

FIG. 4 presents a structure with a non-cut aluminum layer; and

FIG. 5 shows a structure with a cut aluminum layer.

The diagram of FIG. 1 illustrates the linear displacement (arrow) of a plastic film 3 that is first cut, diagrammatically illustrated by a cutting tool 1, after which the edges of the slot 11 created previously are welded, the welding being diagrammatically illustrated by a welding device 2.

On completion of the welding step, the plastic film 3 can undergo another transformation step, for example pasting or film coating. It can also be fashioned on a bag manufacturing or FFS machine. Said step can, moreover, be done in line with the cutting/welding method.

Advantageously, the welding can be followed by a step (not illustrated) in which the weld is covered with an adhesive tape. This step can take place according to various approaches and/or at various points, in particular:
on the winder
at extrusion time
on lamination
on cutting
when the packaging is manufactured, whether this is done on a machine that manufactures preformed bags or an FFS machine that manufactures the bag and fills it in line.

A device used in the context of the present invention can include a blade that cuts the plastic film as it is continually displaced. This blade is preferably immediately followed by a welding tool, ideally a rotary tool to prevent friction. It is also possible to adapt the method according to the invention for the case of step-by-step pulling of the plastic film. This weld can be produced by heating, by contact, by hot air, by high frequency, by ultrasound, or by any other technique that is available on the market.

The methods according to the invention in particular allow for the possibility of using the standard films available on the market. They then use steps (cutting, welding, etc.) that are widely known and mastered in the industrial world. Moreover, the invention can be broken down in various ways as illustrated by the following examples:

FIG. 2 shows a two-layer plastic film 3 with a welding layer 6 and a non-welding layer 5. In this example, a slot 11 is produced through the two layers 5, 6, but only the welding layer 6 is welded. The resulting weld 7 therefore has a height less than that of the two-layer plastic film 3. The weld zone 7 joins together one end of the film 9 with a second end 10. The structure according to FIG. 2 can be produced by laser cutting.

FIG. 3 illustrates the same two-layer structure as FIG. 2, but differs from the latter in that the non-welding layer 5 has not previously been cut. In this case, the plastic film has a face without a slot or weld, which can offer an esthetic and mechanical advantage.

The variants of FIGS. 2 and 3 are each of potential interest. The first is more fragile than the second, but may be too fragile for mechanically demanding applications. The second makes it possible to keep the mechanical properties of the packaging intact. Similarly, all kinds of combinations can be used with the standard films available on the market. If the plastic film includes a layer of aluminum, the latter should not be cut in order to preserve the barrier properties of the aluminum. FIG. 4 illustrates a structure with a non-cut aluminum layer 8. FIG. 5 illustrates a structure with an aluminum layer 8 which has nevertheless been cut. In this second case, ease of tearing has been given priority over the barrier properties of the aluminum layer 8.

The choice of the welding material, of the layer or layers to be cut and the setting of the welding parameters (pressure, time, temperature) makes it possible to adjust the ease of tearing.

The oriented tear in the plastic film can have the desired form (straight or curved). This cut can be continuous or discontinuous (broken line) so as not to excessively embrittle the package.

This zone can be strengthened with an adhesive tape if necessary. The adhesive can be removed on using the plastic film's tear function. This adhesive can also be used to reseal the packaging.

As indicated above, the plastic film according to the invention may be known per se. It can be:
a PE
a PP
a coextruded plastic film of PA/PE type, for example
a layered plastic film
a laminated plastic film of PET/PE, OPP/PE, OPA/PE, PET/alu/PE, PE/alu/PE, PP/alu/PP, PET/alu/PP type, or any other standard composition.

Packaging involving a plastic film according to the invention can be used in all fields that require a preexisting tear zone.

The invention can in particular be used with the following packaging:
bags that stand upright (doypack™, for example), preformed or manufactured on FFS machine;
flat bags with three or four welds;
bags with resealing ZIP for which the accuracy of the opening is important to the opening/closure functionality;
“flowpacks”, satchel bags, or any other film-based packaging can also be advantageously handled in this way.

1. A plastic film (3) comprising a preexisting oriented tear zone (4), characterized in that said zone (4) comprises at least one butt weld (7) joining two parts of said plastic film (3).

2. The plastic film (3) as claimed in claim 1, consisting of several overlaid layers (5, 6, 8).

3. The plastic film as claimed in claim 1, in which the weld (7) extends over the entire thickness of the plastic film (3).

4. The plastic film as claimed in claim 1, in which the weld (7) extends over a height less than the thickness of the plastic film (3).

5. The plastic film as claimed in claim 3, characterized in that the weld (7) is located in a region of the plastic film (3) defined by a preexisting slot (11), the thickness of which is less than the thickness of the plastic film (3).

6. A method for manufacturing a preexisting oriented tear zone (4) in a plastic film (3), characterized in that said zone is obtained by attaching two parts of said plastic film (3) by means of a weld (7).

7. The method as claimed in claim 6, characterized by a first step in which a slot (11) is produced in the plastic film (3) followed by a second step in which the slot (11) is sealed by welding.

8. The method as claimed in claim 7, characterized in that a slot (11) is produced, the thickness of which is less than the thickness of the plastic film (3).

9. The method as claimed in claim 6, in which the weld (7) is positioned on only a part of the thickness of the plastic film (3).

10. The method as claimed in claim 6, comprising the displacement of a plastic film (3) in a direction and the cutting of the plastic film (3) in the same direction followed by the welding of the edges of the resulting slot (11).

11. A device for implementing the method defined in claim 6, comprising the following elements:
means for displacing a plastic film (3) in a direction;
cutting means (1) for producing a slot (11) in the plastic film (3);
means (2) for welding the edges of said slot (11);
optionally, means for depositing an adhesive on a weld (7) made in said slot (11); the cutting means (1), the welding means (2) and optionally the means for depositing an adhesive being positioned in succession one after the other, in said direction.
